(19) United States
(12) Patent Application Publication
(10) Pub. No.: US 2024/0069534 A1
(43) Pub. Date: Feb. 29, 2024

(54) System and Method for Sheet Forming Multiple Parts Using a Common Addendum

(71) Applicant: The Boeing Company, Chicago, IL (US)

(72) Inventors: James O. Border, Brisbane (AU); Andrew J. Stephan, Brisbane (AU); Michael C. Elford, Springfield (AU)

(73) Assignee: The Boeing Company, Chicago, IL (US)

(21) Appl. No.: 17/897,449

(22) Filed: Aug. 29, 2022

(51) Int. Cl. G05B 19/418; B21D 22/26; B21D 31/00

(52) U.S. Cl. CPC G05B 19/4187; B21D 22/26; B21D 31/005; B21D 53/92

(57) ABSTRACT

A method for forming a blank of sheet material includes a step of forming a target shape from the blank. The target shape includes a plurality of component structures connected via a common addendum. Each one of the plurality of component structures has a component-shape and a component-boundary. The common addendum extends between the component-boundary of each one of plurality of component structures and connects the component-boundary of each one of the plurality of component structures with a perimeter of the blank. The method minimizes a projected area of the common addendum via adjustment of a position and/or orientation of each of the component structures, thereby reducing a total amount of sheet material required to form the component structures.

### FIELD

The present disclosure relates generally to forming a sheet material and, more particularly, to a system and method for forming multiple component structures joined by a common addendum, which extends beyond boundaries of the component structures, from a blank of sheet material.

### BACKGROUND

Sheet forming is a process for creating a component from a blank of sheet material through mechanical deformation. During forming, the blank is reshaped without adding or removing material. Various sheet forming techniques exist, such as incremental sheet forming (ISF), deep drawing, stamping, fluid forming, hydroforming, superplastic forming, creep forming, blow forming, rubber pad forming, multi-point contact forming, explosive forming, and the like. However, these forming techniques have drawbacks that can limit their cost effectiveness. As an example, these forming techniques can result in an undesirable amount of scrap material, which is formed by portions of the blank not used to form the final component.

### SUMMARY

Disclosed are examples of a method for forming a blank of sheet material, a system for forming a sheet material, and a structure formed from a blank of sheet material. The following is a non-exhaustive list of examples, which may or may not be claimed, of the subject matter according to the present disclosure.

In an example, the disclosed method includes a step of forming a target shape from a blank of sheet material. The target shape includes a plurality of component structures connected via a common addendum. Each one of the plurality of component structures has a component-shape and a component-boundary. The common addendum extends between the component-boundary of each one of the plurality of component structures and connects the component-boundary of each one of the plurality of component structures with a perimeter of the blank.

In an example, the disclosed system includes a forming machine. The forming machine is configured to form a target shape from the blank. The system includes a computer. The computer is in communication with the forming machine. The computer includes a data processing system configured to determine a component-shape and x, y, z coordinates of a component-boundary of each one of a plurality of component structures to be formed from the blank. The data processing system is configured to generate an addendum-shape of a common addendum to be formed from the blank. The common addendum extends between the component-boundary of each one of the plurality of component structures and connects the component-boundary of each one of the plurality of component structures with a perimeter of the blank. The data processing system is configured to operate the forming machine to form the target shape from the blank. The target shape includes the plurality of component structures and the common addendum.

In an example, the disclosed structure includes a plurality of component structures. Each one of the plurality of component structures includes a component-shape and a component-boundary. The structure includes an addendum, also referred to herein as a common addendum. The common addendum extends between the component-boundary of each one of the plurality of component structures. The common addendum connects the component-boundary of each one of the plurality of component structures with a perimeter of a blank of sheet material. An addendum-shape of the common addendum is generated using a computer by representing the addendum-shape as a function in a form of h(x, y) and solving a partial differential equation of ∇^{2k} h(x, y)=g(x, y), subject to boundary conditions, at x, y coordinates on an XY datum plane to obtain the function h(x, y). The function h(x, y) is a height of the addendum-shape relative to the XY datum plane for the x, y coordinates on the XY datum plane. The variable k is a positive integer. The symbol ∇ represents the gradient operator. The function g(x, y) is a forcing function.

Other examples of the disclosed method, system, and structure will become apparent from the following detailed description, the accompanying drawings, and the appended claims.

### BRIEF DESCRIPTION OF THE DRAWINGS

FIG. 1 is a flow diagram of an example of a method for forming a blank of sheet material;

FIG. 2 is a flow diagram of an example of a method for performing an optimization operation for forming a structure form the blank of sheet material;

FIG. 3 is a flow diagram of an example of a method for solving a partial differential equation for generating a common addendum of the structure;

FIG. 4 is a schematic block diagram of an example of a system for forming the blank of sheet material;

FIG. 5 is a schematic illustration of an example of the structure formed from the blank of sheet material;

FIG. 6 is a schematic illustration of an example of the structure, having a target shape, formed from the blank of sheet material;

FIG. 7 is a schematic illustration of another example of the structure, having the target shape, formed from the blank of sheet material;

FIG. 8 is a schematic illustration of an example of the structure being formed from the blank of sheet material;

FIG. 9 is a schematic illustration of an example of component structures in initial positions and orientations and projected onto a datum plane;

FIG. 10 is a schematic illustration of an example of a projection onto the datum plane of the component structures of FIG. 9 in the initial positions and orientations;

FIG. 11 is a schematic illustration of an example of the component structures in optimized positions and orientations and projected onto the datum plane;

FIG. 12 is a schematic illustration of an example of the projection onto the datum plane of the component structures of FIG. 11 in the optimized positions and orientations;

FIG. 13 is a schematic illustration of an example of a forming machine;

FIG. 14 is a schematic illustration of another example of the forming machine;

FIG. 15 is a schematic illustration of another example of the forming machine;

FIG. 16 is a schematic illustration of an example of an addendum-shape generated for the common addendum of the structure;

FIG. 17 is a block diagram of an example of a data processing system;

FIG. 18 is a schematic illustration of an example of an aircraft; and

FIG. 19 is a flow diagram of an example of an aircraft service method.

### DETAILED DESCRIPTION

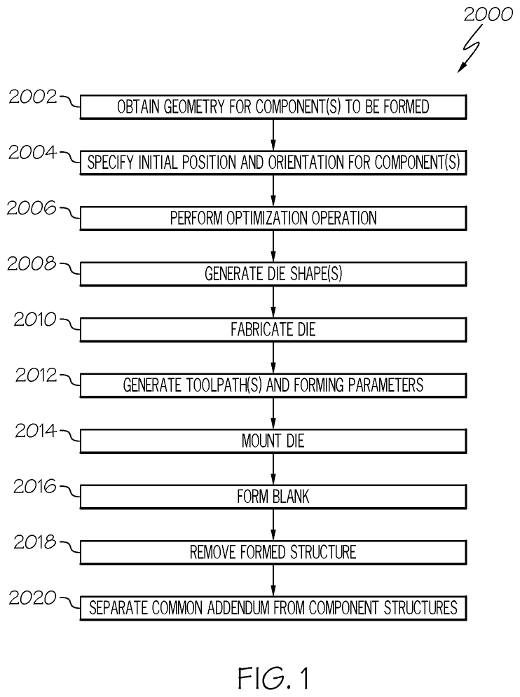

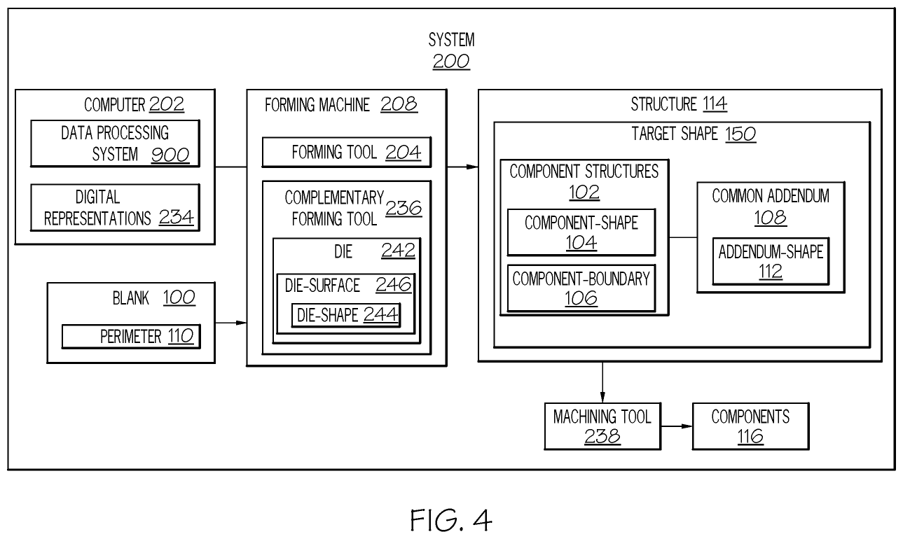

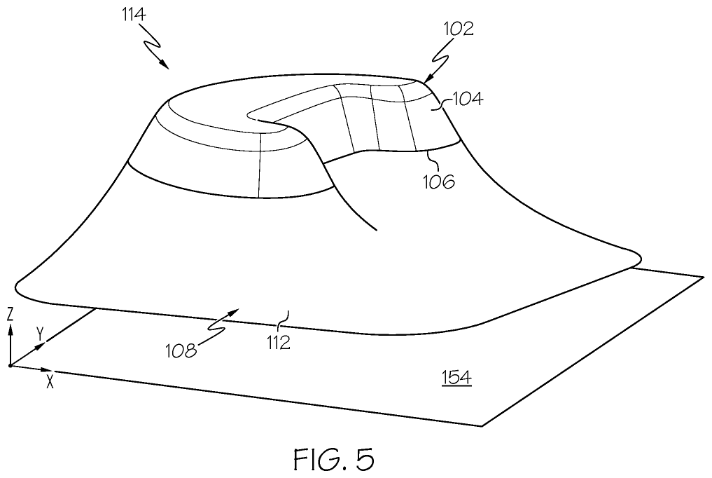

Referring generally to FIGS. 1-4, the present disclosure is directed to examples of a method 2000 (e.g., shown in FIG. 1) and a system 200 (e.g., shown in FIG. 4) for forming a blank 100 of sheet material. The present disclosure is also directed to examples of a structure 114 (e.g., shown in FIGS. 5-7) formed from the blank 100 of sheet material.

As used herein, a sheet material refers to a piece of metal material where one dimension (e.g., thickness) of the piece of metal material is much less than its other dimensions. Examples of the metal material include, but are not limited to, aluminum, titanium, copper, steel (e.g., stainless, galvanized, carbon steel, etc.), alloys or combinations thereof, and the like. General use of the term blank 100 refers to an initial form or structural configuration of the sheet material (e.g., a substantially planar piece of metal) prior to forming the structure 114.

Referring to FIG. 1, in one or more examples, the method 2000 includes the step of (block 2016) forming the blank 100 into a target shape 150 (e.g., forming the structure 114 having the target shape 150). The structure 114 includes or defines a plurality of component structures 102 and an addendum 108, also referred to herein as a common addendum 108 (e.g., as shown in FIG. 4).

In one or more examples, the target shape 150 of the structure 114 includes a plurality of component-shapes 104 and an addendum-shape 112. The target shape 150 may optionally include an adjustment for springback compensation.

In one or more examples, each one of the component structures 102 has a component-shape 104 and a component-boundary 106 (e.g., as shown in FIG. 4). The common addendum 108 includes the addendum-shape 112 (e.g., as shown in FIG. 4).

In one or more examples, the common addendum 108 connects the component-boundary 106 of each one of the component structures 102 with a perimeter 110 of the blank 100. In other words, the structure 114 (e.g., as shown in FIG. 4) includes the plurality of the component structures 102 and the common addendum 108.

In one or more examples. component structures 102 are provided as digital representations 234 (e.g., as shown in FIG. 4). The digital representations 234 include, but are not limited to, Computer Aided Design (CAD) models, whereby the geometry of the component structures 102 are represented by a collection of trimmed parametric surfaces. Alternatively, the digital representations 234 of the component structures 102 may include a plurality of polygons, such as for a mesh-based digital representation.

In one or more examples, according to the method 2000, the step of (block 2016) forming the blank 100 into the target shape 150 is performed using a forming tool 204 (e.g., as shown in FIG. 4). In one or more examples, the forming tool 204 interacts with the blank 100 to elastoplastically deform the blank 100 into the target shape 150. In other words, the forming tool 204 applies a sufficient load to the blank 100 such that the load results in elastoplastic deformation and causes the blank 100 to permanently change shape, for example, from a flat, planar shape to the target shape 150 of the structure 114.

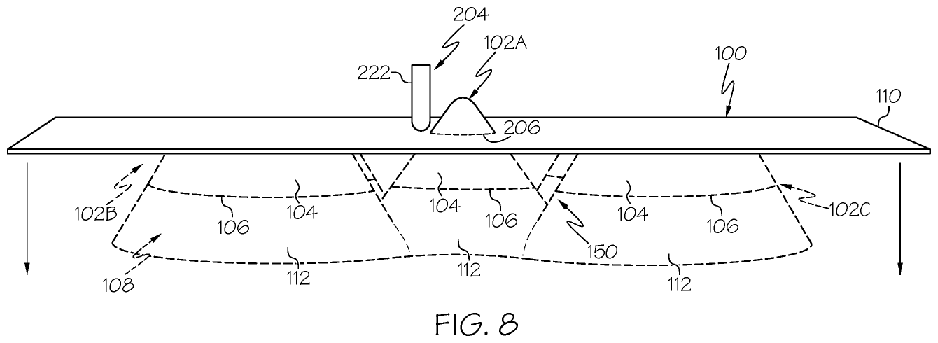

In one or more examples, according to the method 2000, the step of (block 2016) forming the blank 100 into the target shape 150 includes a step of operating the forming tool 204, with a computer (e.g., computer 202 shown in FIG. 4), according to a tool path 206 (e.g., as shown in FIG. 8) relative to the blank 100.

In one or more examples, more than one forming tool 204 may be used to form the target shape 150. One or more of the forming tools 204 may move relative to the blank 100 according to one or more tool paths 206 to form the target shape 150, which includes a plurality of the component-shapes 104 and the addendum-shape 112.

In one or more examples, the forming operation (e.g., block 2016) may be performed by any one of various sheet forming techniques using any one of various suitable types of forming machines (e.g., a forming machine 208 shown in FIG. 4). Examples of suitable sheet forming techniques include, but are not limited to, incremental sheet forming, deep drawing, stamping, fluid forming, hydroforming, superplastic forming, creep forming, blow forming, rubber pad forming, multi-point contact forming, explosive forming, and the like.

In one or more examples, according to the method 2000, the step of (block 2016) forming the blank 100 into target shape 150 includes a step of performing an incremental sheet forming operation. In these examples, the forming machine 208 (e.g., shown in FIG. 4) includes or takes the form of an incremental sheet forming machine. The forming tool 204 includes or takes the form of at least one stylus tool 222 (e.g., as shown in FIG. 8). In such examples, use of the forming tool 204, operating according to one or more tool paths 206, enables incremental formation of the target shape 150. Generally, as is known in the art, the incremental sheet forming operation includes incrementally forming the blank 100 using the stylus tool 222 that moves along the tool path 206. The tool path 206 is formed by a plurality of planar contours, generated by intersecting the target shape 150 with a plurality of planes spaced apart from each other.

In one or more examples, according to the method 2000, the step of (block 2016) forming the blank 100 into target shape 150 includes performing a deep drawing operation. In these examples, the forming machine 208 (e.g., shown in FIG. 4) includes or takes the form of a deep drawing machine. The forming tool 204 includes or takes the form of an upper punch tool, a lower die tool, and, optionally, one or more guide tools. Generally, as is known in the art, the deep drawing operation includes lowering the upper punch tool into the lower die tool to form the target shape 150 from the blank 100. At least one of the punch tool and the die tool has at least one surface that is a subset of the target shape 150.

In one or more examples, according to the method 2000, the step of (block 2016) forming the blank 100 into target shape 150 includes performing a hydroforming operation. In these examples, the forming machine 208 includes or takes the form of a hydroforming machine. Generally, as is known in the art, the hydroforming operation includes applying a pressurized fluid, optionally contained within a rubber diaphragm or bladder, to one side of the blank 100. The blank 100 is constrained by a first (e.g., upper) tool above the blank 100 and a second (e.g., lower) supporting tool below the blank 100. At least one of the supporting tools has at least one surface that is a subset of the target shape 150.

Generally, implementations of disclosed examples of the method 2000 and the system 200 facilitate a reduction in the amount of scrap metal generated during a sheet forming operation by providing methodologies for minimizing an amount of sacrificial material required for forming one or more metal components from a blank of sheet material. This sacrificial material is referred to herein as addendum. Expressed another way, the addendum refers to a portion of the sheet material that does not form any portion of the final component but is required to enable formation of a component structure using the sheet forming operation. Reference herein to a common addendum refers to the addendum that is common to and that extends between multiple component structures and that is required to enable formation of the multiple component structures using the sheet forming operation.

As described in herein, examples of the method 2000 and the system 200 enable generation of the addendum by solving a partial differential equation with boundary conditions within an optimization loop.

Examples of the method 2000 and the system 200 enable minimization of the common addendum projected surface area, where the projection is onto an XY datum plane. The method 2000 provides a means to solve a two-dimensional packing problem which is constrained by formability metrics. The formability metrics may be specific to the chosen forming operation (e.g., geometry accuracy and thinning). In a first case, the sheet size of the blank has a variable length and width and there is a fixed plurality of components to be formed from the blank. In a second case, the sheet size of the blank is fixed and there is a given plurality of components to be formed, from which a subset can be selected. Each of these cases are provided degrees of freedom, which correspond to the positions and/or rotations of each of the components to be formed and, in the first case, the length and width of the blank.

As described herein, minimization of the addendum is achieved by optimizing the position and orientation of the component structures to be formed from the blank relative to each other and, subsequently, generating an optimal shape of the addendum to be formed from the blank that is common to and that connects the shapes of the components. This results in a reduction in the amount of wasted sheet material. Additionally, in some forming operations, examples of the method 2000 and system 200 facilitate a reduction in forming time per component (e.g., incremental sheet forming operations).

Referring still to FIG. 1, in one or more examples, the method 2000 includes a step of (block 2002) obtaining the geometry for each one of the one or more components 116 to be formed using a forming operation. Generally, the geometry of the component 116 refers to or includes the component-shape 104 and the component-boundary 106 of the component structure 102. In one or more examples, the geometries of the components 116 are acquired from digital representations (e.g., models) of the components 116. In one or more examples, the geometries of the components 116, or of the component-shapes 104 of the component structures 102 to be formed from the blank 100, are provided (e.g., input into the computer 202 shown in FIG. 4).

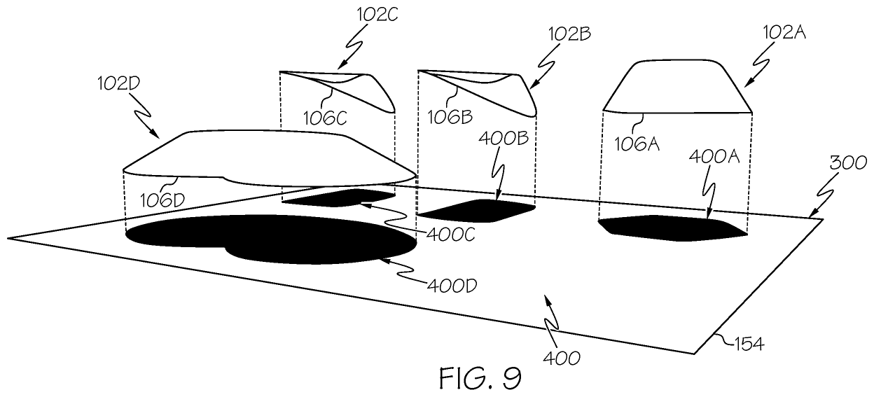

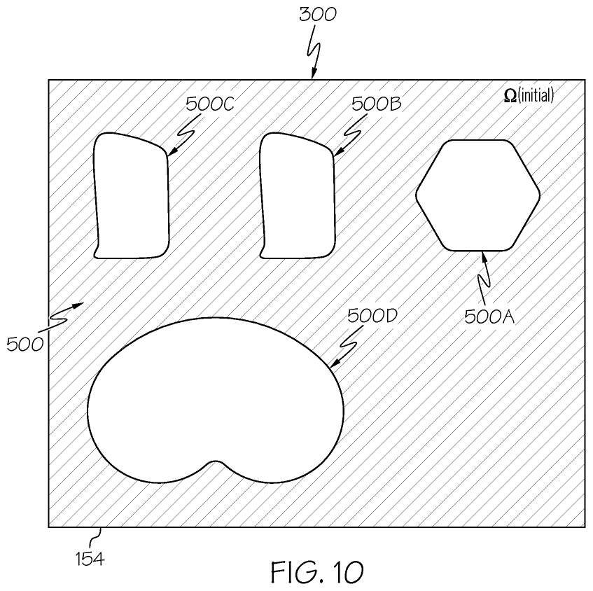

In one or more examples, the method 2000 includes a step of (block 2004) specifying initial positions and orientations for the components 116. The initial position and orientation of the components 116 are represented by the initial position and orientation of the component-shape 104 of each one of the component structures 102 to be formed with respect to the XY datum plane 154 (e.g., as shown in FIGS. 9 and 10). In one or more examples, the initial positions and orientations of the components 116, or of the component-shapes 104 of the component structures 102 to be formed from the blank 100, are provided (e.g., input into the computer 202 shown in FIG. 4).

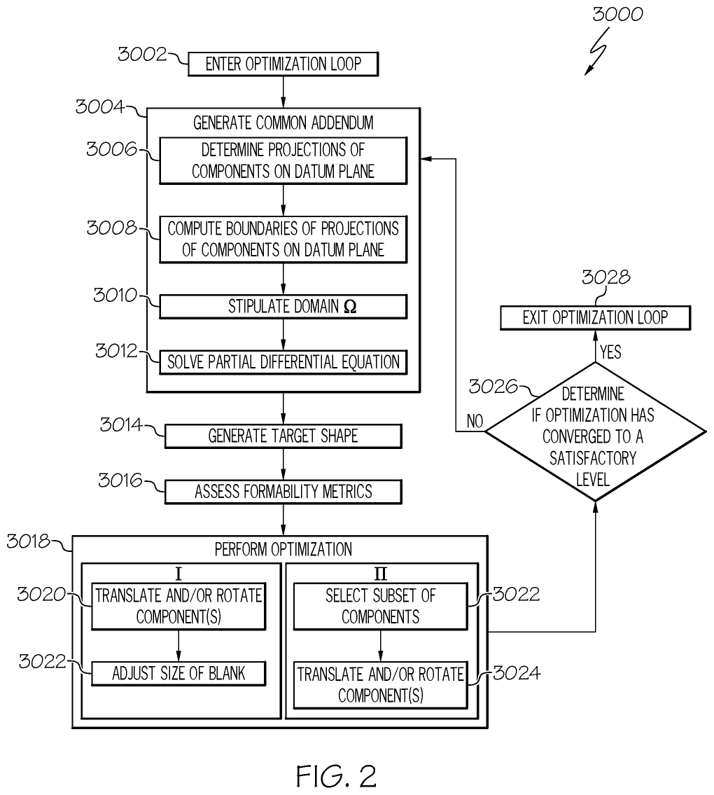

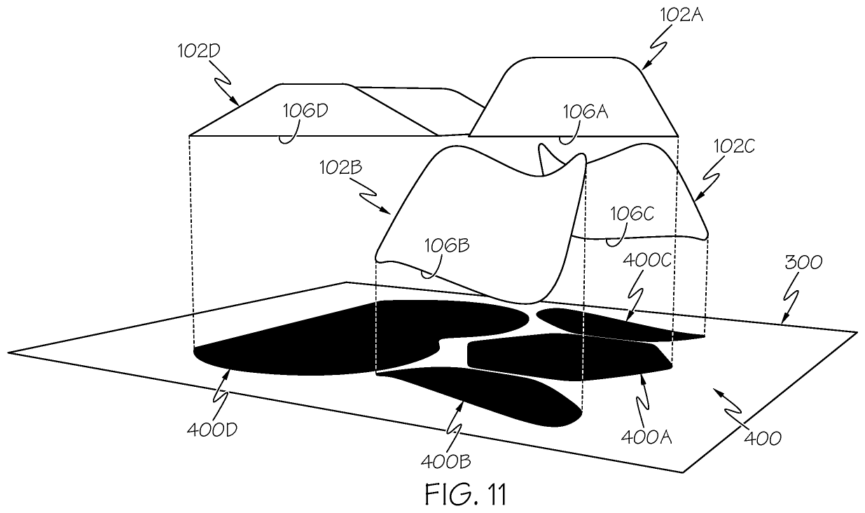

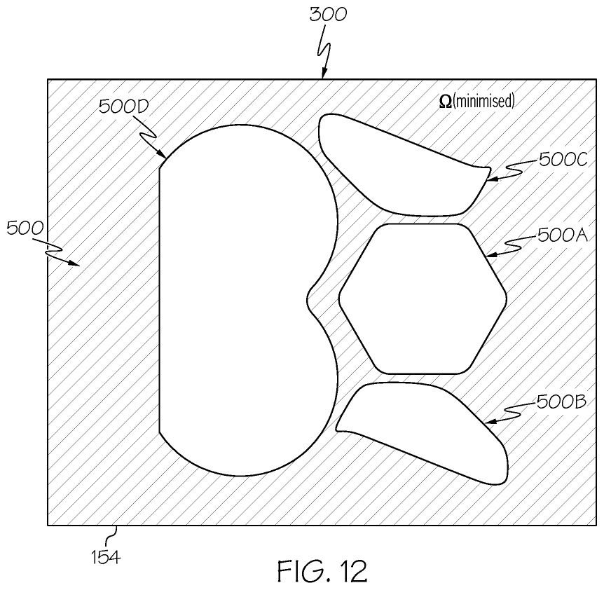

In one or more examples, the method 2000 includes a step of (block 2006) performing an optimization operation (e.g., an optimization loop). The step of (block 2006) performing the optimization operation arranges the components 116 and provides optimized positions and orientations for the components 116, or of the component-shapes 104 of the component structures 102 to be formed from the blank 100, to minimize a projected surface area of the common addendum 108 (e.g., as shown in FIGS. 11 and 12). In one or more examples, the step of (block 2006) performing the optimization operation is further described below by method 3000 and illustrated in FIG. 2.

In one or more examples, the method 2000 also includes a step of selecting the desired type of forming machine 208 and/or forming tools 204 (e.g., as shown in FIG. 4). The method 2000 also includes a step of selecting the type (e.g., composition, thickness, etc.) of the blank 100 of sheet material.

In one or more examples, the method 2000 includes a step of (block 2008) generating one or more die-shapes 244 associated with one or more dies 242 (e.g., as shown in FIG. 4). In one or more examples, the die-shape 244 corresponds to an entirety of the target shape 150. In one or more examples, the die-shape 244 corresponds to a portion of the target shape 150. As an example, the geometry of the die-surface 246 (e.g., the die-shape 244) is generated and output to the computer 202 (e.g., FIG. 4) based on the completed geometry of the target shape 150 as optimized.

In one or more examples, the method 2000 includes a step of (block 2010) fabricating or otherwise manufacturing the die 242 (e.g., shown in FIG. 4). The die 242 includes the geometry generated for the die-shape 244 (e.g., block 2008). In one or more examples, the die 242 is manufactured or otherwise fabricated through computer numerical control (CNC) machining, additive manufacturing, and the like.

In one or more examples, the method 2000 also includes a step of fabricating or otherwise manufacturing (e.g., machining, lathing, additively manufacturing etc.) any other tools required or associated with a selected forming operation or type of forming machine 208.

In one or more examples, the method 2000 includes a step of (block 2012) generating one or more tool paths 206 for operation of the forming tool 204 during the forming operation. As an example, the forming tool 204 (e.g., the stylus tool 222 in the incremental sheet forming operation) moves along the one or more tool paths 206 to form the target shape 150. As an example, the tool paths 206 are generated by the computer 202 (e.g., FIG. 4).

In one or more examples, the method 2000 also includes a step of setting one or more parameters for the forming machine 208. The parameters define operating conditions for the forming machine 208 during the forming operation and may vary depending on the type of forming operation or type of forming machine.

In one or more examples, the method 2000 includes a step of (block 2014) mounting the die 242 to the forming machine 208, as required for the selected forming operation. Additionally, or alternatively, in one or more examples, the method 2000 includes mounting any other tooling to the forming machine 208, as required for the selected forming operation.

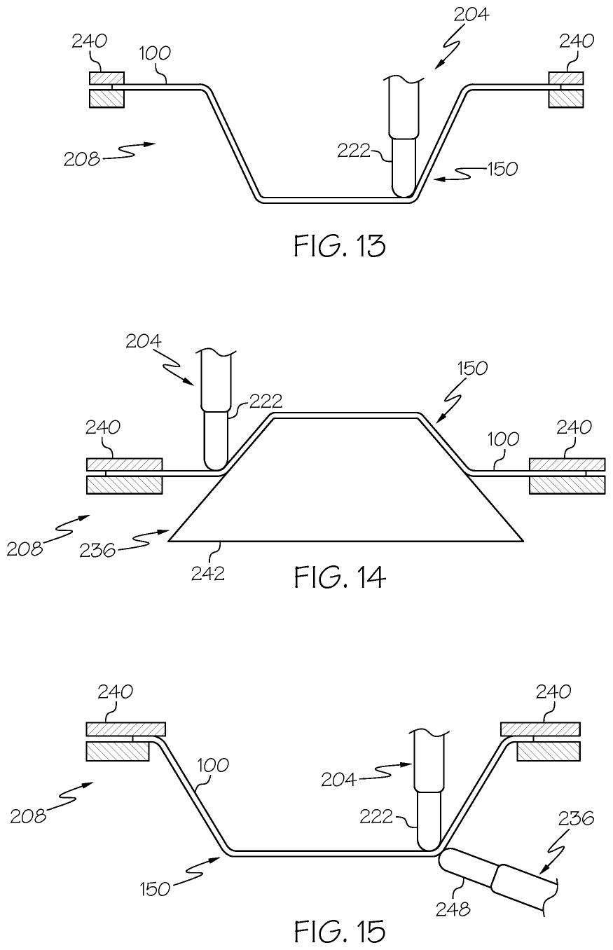

In one or more examples, the method 2000 includes a step of (block 2016) forming the blank 100 into the structure 114 using the forming machine 208. In one or more examples, the blank 100 is formed over the die 242 to form the structure 114 using the forming machine 208. As an example, the step of (block 2016) forming the blank 100 includes incremental sheet forming using the stylus tool 222 (e.g., as shown in FIGS. 13-15).

In one or more examples, the method 2000 includes a step of (block 2018) removing the structure 114 having the target shape 150 from the forming machine 208 after completion of the forming operation. As an example, the structure 114 is removed from the die 242 after completion of the forming operation.

In one or more examples, the method 2000 includes a step of (block 2020) separating the common addendum 108 from the component structures 102 and then scrapping the common addendum 108. In at least one example, the common addendum 108, separated from the component structures 102 and scrapped, is recycled. Generally, the common addendum 108 is separated from the component structures 102 along the component-boundaries 106 in order to retain a plurality of the components 116. The step of (block 2020) separating the common addendum 108 from the component structures 102 is achieved by any suitable process or technique, including, but not limited to, milling, routing, plasma-jet cutting, water-jet cutting, manually cutting and the like.

Referring now to FIG. 2, which illustrates an example of the method 3000 for performing an optimization operation for forming the structure 114 from the blank 100. Generally, implementations of the method 3000 are employed for optimization of the components to minimize a projected area of the addendum. In one or more examples, the method 3000 is an implementation of a portion of the method 2000 (FIG. 1). In one or more examples, the method 3000 in an implementation of the step of (block 2006) performing the optimization operation of the method 2000.

In one or more examples, the method 3000 includes a step of (block 3002) entering an optimization loop. In one or more examples, upon entering the optimization loop, the method 3000 includes a step of (block 3004) generating the common addendum 108. The generation of the common addendum 108 and, more particularly, the addendum-shape 112 of the common addendum 108 is represented as the function h(x, y).

In one or more examples, the step of (block 3004) generating the common addendum 108 includes a step of (block 3006) determining a component-projection 400 of each one of the components 116 onto the XY datum plane 154 (e.g., as shown in FIG. 9). In one or more examples, the component-projection 400 is a projection of the component-shape 104 of each one of the component structures 102 corresponding to the components 116 to be formed by the forming operation onto the XY datum plane 154.

In one or more examples, the step of (block 3004) generating the common addendum 108 includes a step of (block 3008) computing a projection boundary 500 for each component-projection 400 of each one of the components 116 (e.g., as shown in FIG. 10). In one or more examples, the projection boundary 500 is the set of points on the XY datum plane 154 that lie on the boundary of each of the component-projections 400 of each one of the components 116 to be formed by the forming operation.

In one or more examples, the step of (block 3004) generating the common addendum 108 includes a step of (block 3010) stipulating a domain Ω. In one or more examples, the domain Ω represents or includes a portion of the XY datum plane 154 which is bounded by the projection boundaries 500 of all the components 116 and the perimeter 110 of the blank 100 projected onto the XY datum plane 154 (e.g. as shown in FIGS. 9 and 10).

Referring now to FIG. 9, a first component-projection 400A represents a projection of a first component structure 102A at an initial position and orientation. A second component-projection 400B represents a projection of a second component structure 102B at an initial position and orientation. A third component-projection 400C represents a projection of a third component structure 102C at an initial position and orientation. A fourth component-projection 400D represents a projection of a fourth component structure 102D at an initial position and orientation. It can be appreciated that more or less component-projections 400, representing more or less component structures 102, corresponding to more or less components 116 to be formed by the forming operation, may be used.

Referring now to FIG. 10, which illustrates an example of a plurality of projection boundaries 500 of the component structures 102, corresponding to the components 116 to be formed by the forming operation, onto the XY datum plane 154 before optimization (e.g., block 2006 of the method 2000 and/or the method 3000). FIG. 11 also illustrates an example of the blank-projection 300 of the blank 100 (e.g., the perimeter 110 of the blank 100) onto the XY datum plane 154 before optimization (e.g., the method 3000). As an example, FIG. 11 illustrates an implementation of the step of (block 3006) determining the projection of components onto the datum plane and the step of (block 3008) computing the projection boundary 500 of each one of the components 116 on the XY datum plane 154.

In the illustrated example, a first projection boundary 500A represents a projection of a first component-boundary 106A (FIG. 9) of the first component structure 102A at the initial position and orientation. A second projection boundary 500B represents a projection of a second component-boundary 106B (FIG. 9) of the second component structure 102B at the initial position and orientation. A third projection boundary 500C represents a projection of a third component-boundary 106C (FIG. 9) of the third component structure 102C at the initial position and orientation. A fourth projection boundary 500D represents a projection of a fourth component-boundary 106D (FIG. 9) of the fourth component structure 102D at the initial position and orientation. It can be appreciated that more or less projection boundaries 500, associated with more or less component structures 102, corresponding to more or less components 116 to be formed by the forming operation, may be used.

FIG. 10 also illustrates an example of the domain Ω before the step of optimization (e.g., block 2006 of the method 2000 and/or the method 3000). The domain Ω, illustrated in FIG. 11, represents or includes a portion of the XY datum plane 154 that is bounded by the projection boundaries 500 of all the component structures 102 (e.g., components 116 to be formed) and the perimeter 110 of the blank 100 projected onto the XY datum plane 154 before optimization (e.g., the method 3000).

Referring now to FIG. 11, which illustrates an example of the plurality of component-projections 400 of the component structures 102, corresponding to the components 116 to be formed by the forming operation, onto the XY datum plane 154 after optimization (e.g., the method 3000). FIG. 11 also illustrates an example of the blank-projection 300 of the blank 100 onto the XY datum plane 154 after optimization (e.g., the method 3000).

In the illustrated example, the first component-projection 400A represents the projection of the first component structure 102A at an adjusted, or optimized, position and orientation to minimize the surface area of the blank-projection and, thus, the surface area of the common addendum 108. The second component-projection 400B represents the projection of the second component structure 102B at an adjusted, or optimized, position and orientation to minimize the surface area of the blank-projection and, thus, the surface area of the common addendum 108. The third component-projection 400C represents the projection of the third component structure 102C at an adjusted, or optimized, position and orientation to minimize the surface area of the blank-projection and, thus, the surface area of the common addendum 108. The fourth component-projection 400D represents the projection of the fourth component structure 102D at an adjusted, or optimized, position and orientation to minimize the surface area of the blank-projection of the common addendum 108.

Referring now to FIG. 12, which illustrates an example of the plurality of projection boundaries 500 of the component structures 102, corresponding to the components 116 to be formed by the forming operation, onto the XY datum plane 154 after optimization (e.g., the method 3000). FIG. 12 also illustrates an example of the blank-projection 300 of the blank 100 (e.g., the perimeter 110 of the blank 100) onto the XY datum plane 154 after optimization (e.g., the method 3000).

In the illustrated example, the first projection boundary 500A represents the projection of the first component-boundary 106A (FIG. 11) of the first component structure 102A at the adjusted, or optimized, position and orientation. The second projection boundary 500B represents the projection of a second component-boundary 106B (FIG. 11) of the second component structure 102B at the adjusted, or optimized, position and orientation. The third projection boundary 500C represents the projection of the third component-boundary 106C (FIG. 11) of the third component structure 102C at the adjusted, or optimized, position and orientation. The fourth projection boundary 500D represents the projection of the fourth component-boundary 106D (FIG. 11) of the fourth component structure 102D at the adjusted, or optimized, position and orientation.

FIG. 12 also illustrates examples of a minimized domain Ω after optimization. The minimized domain Ω, illustrated in FIG. 12, represents or includes a portion of the XY datum plane 154 that is bounded by the projection boundaries 500 of all the component structures 102 (e.g., components 116 to be formed) and the perimeter 110 of the blank 100 projected onto the XY datum plane 154 after optimization (e.g., in adjusted, or optimized, positions and orientations).

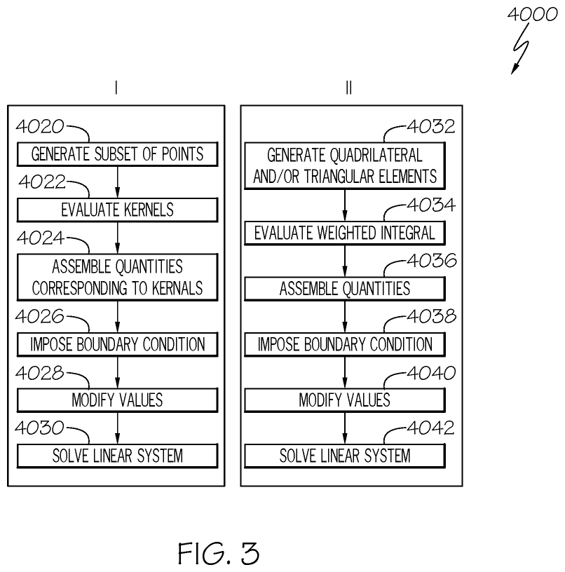

In one or more examples, the step of (block 3004) generating the common addendum 108 includes a step of (block 3012) solving the partial differential equation ∇^{2k} h(x, y)=g(x, y), wherein k∈Z⁺ over the domain Ω, with specified boundary conditions. The step of (block 3012) solving the partial differential equation provides or results in the surface of the common addendum 108 (e.g., the addendum-shape 112) represented by the function h(x, y). In one or more examples, the step of (block 3012) solving the partial differential equation is further described below by method 4000 and illustrated in FIG. 3.

Accordingly, the addendum-shape 112 for the common addendum 108 to be formed from the blank 100 is generated such that the common addendum 108 spans between the component-boundaries 106 of the component structures 102 to be formed and the perimeter 110 (e.g., edge) of the blank 100. The addendum-shape 112 is generated by solving the partial differential equation ∇^{2k} h(x, y)=g(x, y), wherein k∈Z+ and h is the height of the common addendum surface above the XY datum plane 154 at some x, y coordinate. The partial differential equation is solved subject to the boundary conditions, which specify the continuity at the component-boundary 106 of the component structure 102 of each component to be formed.

In one or more examples, the method 3000 includes a step of (block 3014) generating the target shape 150. In one or more examples, the target shape 150 is generated by joining all of the components 116 (e.g., the component-shapes 104 of the component structures 102) with the common addendum 108 (e.g., the addendum-shape 112) represented by the function h(x, y).

In one or more examples, geometry of the target shape 150 is also used to define the geometry of the die-surface 246 of the die 242 (e.g., shown in FIG. 4) over which the blank 100 will be formed.

In one or more examples, the method 3000 includes a step of (block 3016) assessing formability metrics (e.g., indicators of formability). In one or more examples, the formability metrics are assessed through a numerical simulation of the forming process, through physical forming trials, through machine learning, or any combination of thereof.

In one or more examples, the formability metrics are checked for the target shape 150 with respect to the desired type of forming operation. Examples of the formability metrics include, but are not limited to, minimum sheet thickness and maximum wall angle as well as operation specific considerations, such as, in the case of incremental sheet forming, where the forming tool 204 (e.g., the stylus tool 222), must physically be able to fit in all parts of the geometry of the target shape 150.

In one or more examples, the geometry of target shape 150 is adjusted to account for elastic spring back of the sheet following the forming operation.

In at least one example, the numerical simulation consists of performing a finite element analysis of the forming process to obtain the formability metrics, which include minimum predicted sheet thickness and/or maximum effective plastic strain.

In one or more examples, the step of (block 3016) assessing the formability metrics verifies that the blank 100 is capable of being formed over the geometry of the die-surface 246 of the die 242 (e.g., the die-shape 244 shown in FIG. 4).

In one or more examples, the method 3000 includes a step of (block 3018) performing a constrained optimization using a known mathematical optimization algorithm, such as a Nelder Meade algorithm, a gradient descent algorithm, a genetic evolution algorithm, a differential evolution algorithm or the like. In these examples, the objective function of the optimization is to minimize the projected area of the common addendum 108 and the constraints are given by one or more forming metrics.

In one or more examples, the step of (block 3018) performing the optimization can be performed according to a first method I or a second method II.

In one or more examples, according to a first method I, the step of (block 3018) performing the optimization includes a step of (block 3020) translating and/or rotating one or more of the components 116 (e.g., the component-shapes 104 of the component structures 102 corresponding to the components 116 to be formed). In one or more examples, translation and/or rotation of the components 116 are performed according to (e.g., are informed by) the optimization algorithm.

In one or more examples, according to the first method I, the step of (block 3018) performing the optimization also includes a step of (block 3022) adjusting a size of the blank 100. In one or more examples, the size of the blank 100 is adjusted to the envelope of the component-projections 400 of the components 116 (e.g., as shown in FIG. 12). In one or more examples, adjustment of the size of the blank 100 is performed according to (e.g., is informed by) the optimization algorithm.

In one or more examples, according to the first method I, the degrees of freedom are the magnitude of X, Y, and Z translation for each component 116, the magnitude of rotation about the X, Y, and Z axis for each component 116, and the dimensions (e.g., length and width) of the blank 100.

In one or more examples, according to the second method II, the step of (block 3018) performing the optimization includes a step of (block 3022) selecting a subset (e.g., two or more) of the components 116 from the entire plurality of components 116 to be formed. In one or more examples, selection of the subset of the components 116 is performed according to (e.g., is informed by) the optimization algorithm.

In one or more examples, according to the second method II, the step of (block 3018) performing the optimization includes a step of (block 3024) translating and/or rotating one or more of the components 116 (e.g., the component-shapes 104 of the component structures 102 corresponding to the components 116 to be formed) of the subset of the components 116. In one or more examples, translation and/or rotation of the components 116 of the subset of the components 116 are performed according to (e.g., are informed by) the optimization algorithm.

In one or more examples, according to the second method II, the degrees of freedom are the magnitude of X, Y, and Z translation for each component 116, the magnitude of rotation about the X, Y, and Z axis for each component 116, and the (e.g., discrete) degree of freedom, which is the selection of the subset of the components 116 to be formed with the blank 100 having fixed dimensions (e.g., a fixed sheet size).

Accordingly, in one or more examples, the step of (block 3018) performing the optimization generally includes arranging the component-shape 104 of one or more of the component structures 102 to be formed from the blank 100 to minimize the projected surface area of the common addendum 108. Arranging the component-shapes 104 (e.g., of all of the components 116 according to the first method I or of a subset of the components 116 according to the second method II) includes translating the component-shape 104 of one or more of the component structures 102 to be formed along the X-axis, the Y-axis, and/or the Z-axis and/or rotating the component-shape 104 of one or more of the component structures 102 to be formed about the X-axis, the Y-axis, and/or the Z-axis. This translation and/or rotation is performed to minimize the surface area of the common addendum 108 as projected onto the XY datum plane 154 (e.g., as shown in FIGS. 11 and 12). Limits of this translation and/or rotation are subject to a condition of no-overlap between the components 116 (e.g., the component-shapes 104 of the component structures 102 corresponding to the components 116 to be formed).

In one or more examples, the method 3000 includes a step of (block 3026) determining whether the optimization (e.g., block 3018) has converged to a satisfactory or desired level. If the optimization has converged to a satisfactory or desired level (e.g., “YES”), then the method 3000 concludes with a step of (block 3028) exiting the optimization loop. If the optimization has not converged to a satisfactory or desired level (e.g., “NO”), then the step of (block 3004) generating the common addendum 108 and the step of (block 3018) performing one step of the optimization are repeated. Accordingly, the optimization loop further minimizes the projected surface area of the common addendum 108 by adjusting or otherwise modifying the position and/or orientation of the components 116 (e.g., the component-shapes 104 of the component structures 102 corresponding to the components 116 to be formed).

Solving of Partial Differential Equation to Obtain Common Addendum Shape

Referring now to FIG. 3, which illustrates an example the method 4000 for solving the partial differential equation for generating a surface of the common addendum 108. Generally, implementations of the method 4000 solve the partial differential equation to obtain the addendum-shape of the common addendum. More particularly, in one or more examples, the method 4000 includes or employs two methods (e.g., ways or techniques), identified as a first method I and second method II, of solving the partial differential equation ∇^{2k} h(x, y)=g(x, y), subject to an appropriate set of boundary conditions, to obtain the surface function h(x, y), which uniquely describes the addendum-shape 112 of the common addendum 108. In other examples, the method 4000 may include or employ other techniques, not described herein, to solve the partial differential equation and obtain the surface function h(x, y). In one or more examples, the method 4000 is an implementation of the step of (block 3012) solving the partial differential equation of the method 3000 (FIG. 2).

In one or more examples, the partial differential equation is solved at x, y coordinates within the domain Ω on an XY datum plane 154. The function h(x, y), which is the function to be solved, provides the height of the addendum-shape 112 along the Z-axis and relative to the XY datum plane 154 for each one of the x, y coordinates of points belonging to the domain Ω. The variable k is a positive integer. The operator ∇ is the gradient operator. The operator ∇²=∇·∇, i.e., ∇² h(x, y)=∇·(∇(h(x, y))). The function g(x, y) is a forcing function. As an example, the function g(x, y) is a user-defined forcing function. In one or more examples, the function g(x, y) is equal to zero. In one or more examples, the function g(x, y) is non-zero across the values of x and y which are in the domain upon which the function h(x, y) is being solved.

In one or more examples, when a value of k is equal to 1, the height of the addendum-shape 112 is equal to a height of the component-shape 104 at any x, y coordinate along the component-boundary 106.

In one or more examples, when a value of k is equal to 2, the height of the addendum-shape 112 is equal to a height of the component-shape 104 at any x, y coordinate along the component-boundary 106 and a tangent plane of the addendum-shape 112 is enforced to be coincident with a tangent plane of the component-shape 104 at any x, y coordinate along the component-boundary 106.

In one or more examples, when a value of k is equal to 3, the height of the addendum-shape 112 is equal to a height of the component-shape 104 at any x, y coordinate along the component-boundary 106, a tangent plane of the addendum-shape 112 is enforced to be coincident with a tangent plane of the component-shape 104 at any x, y coordinate along the component-boundary 106, and the second fundamental form of the addendum-shape 112 is enforced to be equal to the second fundamental form of the component-shape 104 at any x, y coordinate along the component-boundary 106. In these examples, the second fundamental form is the II tensor.

In one or more examples, the method 4000 can be performed using the first method I or the second method II. The first method I details the steps of using the finite difference method to approximate the solution to the partial differential equation ∇^{2k} h(x, y)=g(x, y). The second method II details the steps of using a Galerkin method to approximate the solution to the partial differential equation ∇^{2k} h(x, y)=g(x, y). The second method II may, for example, outline the steps of a finite element approximation to the solution of the partial differential equation ∇^{2k} h(x, y)=g(x, y).

In one or more examples, the first method I of the method 4000 includes a step of (block 4020) generating a subset of points that lie within the domain Ω. The points are spaced in a grid having a regular pattern.

In one or more examples, the first method I of the method 4000 includes a step of (block 4022) evaluating kernels corresponding to a harmonic operator ∇², a bi-harmonic operator ∇⁴, or a higher order even gradient operator ∇^{2k}. In one or more examples, k∈Z⁺ (k is in the set of positive integers).

In one or more examples, the first method I of the method 4000 includes a step of (block 4024) assembling quantities resulting from the evaluation of a kernel at each point in the grid into a matrix A. These quantities may, for example, represent a plurality of finite difference approximations of derivatives at each point.

In one or more examples, the first method I of the method 4000 includes a step of (block 4026) imposing at least one boundary condition.

In one or more examples, the first method I of the method 4000 includes a step of (block 4028) subsequently modifying values contained within the matrix A according to at least one boundary condition.

In one or more examples, the first method I of the method 4000 includes a step of (block 4030) solving a linear system Ah=θ.

In the above examples, h is a column vector containing a height of each point in the grid. θ is a column vector resulting from a combination of at least the one boundary condition and the forcing function g(x, y).

In one or more examples, according to the second method II of the method 4000, the function h(x, y) for the height of the addendum-shape 112 is represented by a linear combination of a plurality of functions with compact support, computed by a Galerkin method.

In one or more examples, the second method II of the method 4000 includes a step of (block 4032) generating at least one of a set of quadrilateral elements and a set of triangular elements on the domain Ω. The domain Ω spans an entirety of the blank 100 minus a projection of the component structures 102 onto the XY datum plane 154 (e.g., as shown in FIGS. 10 and 12.). At least one of the set of quadrilateral elements and the set of triangular elements defines the plurality of functions of the method.

In one or more examples, the second method II of the method 4000 includes a step of (block 4034) evaluating a weighted integral of a quantity dependent on an operator over an area spanned by compact supports (e.g., the area inside a quadrilateral defined by four nodes) and a step of (block 4036) assembling resulting quantities into a matrix B.

In one or more examples, the second method II of the method 4000 includes a step of (block 4038) imposing at least one boundary condition and a subsequent step of (block 4040) modifying values contained within the matrix B according to at least one boundary condition.

In one or more examples, the second method II of the method 4000 includes a step of (block 4042) solving a linear system Bh=τ.

In the above examples, h is a column vector containing function coefficients. T is a column vector resulting from a combination of at least one boundary condition and the forcing function g(x, y).

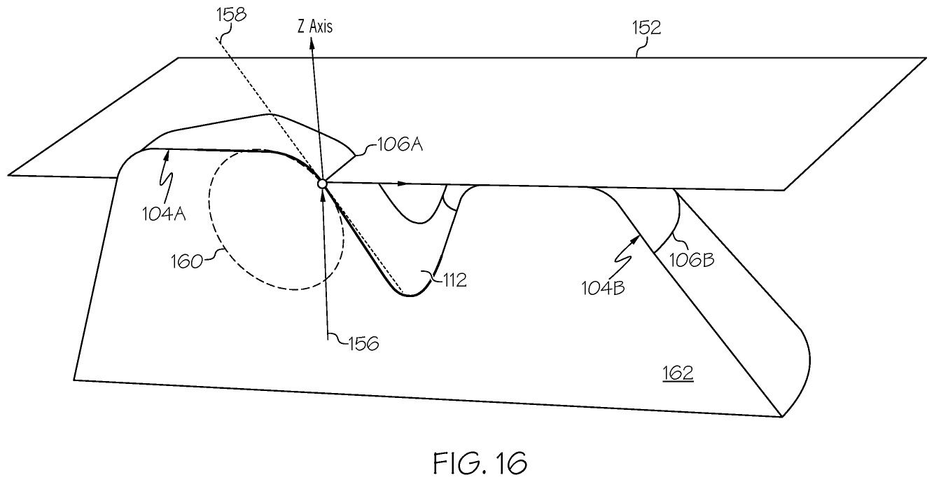

Referring now to FIG. 16, which schematically illustrates an example of the target shape 150, which includes the addendum-shape 112 of the common addendum 108, characterized by some integer k and generated by solving the partial differential equation ∇^{2k} h(x, y)=g(x, y), subject to the boundary conditions, wherein k∈Z⁺.

The at least one boundary condition imposed on the partial differential equation ensures that the height solved for the common addendum 108 is enforced at the component-boundary 106 of each component structure 102 for all values of the positive integer k. This ensures all component surfaces are connected to the common addendum 108 at the component-boundaries 106. Depending on the value of k, the tangency is enforced (for k=2) for all points on the boundary curve and the II tensor, i.e., the second fundamental form, (for k=3) is enforced for all points on the boundary curve.

Referring still to FIG. 16, for a given cross-sectional cut through the target shape 150, running orthogonal to the XY datum plane 154, these constraints enforce the following conditions for each point of interest 156:

For example, k>=1:

Prescribing or enforcing the height (e.g., the addendum-shape 112 has to connect to the component-shape 104 at each point along the component-boundary 106).

For example, k>=2:

Prescribing or enforcing that a slope/tangent line 158 has to match (e.g., the slope of addendum-shape 112 matches the slope of component-shape 104 at the component-boundary 106).

For example, k>=3:

Prescribing or enforcing that the radius of an osculating circle 160 has to match (e.g., the radius of curvature of the addendum-shape 112 matches the radius of curvature of the component-shape 104 at the component-boundary 106).

In one or more examples, the partial differential equation is solved with the boundary conditions enforced by each of the component-boundaries 106 corresponding to a component structure 102. Solving for the partial differential equation provides a unique surface geometry for common addendum 108 when satisfying these boundary conditions. The partial differential equation, in combination with the boundary conditions, enforces one and only one addendum-shape 112 for the common addendum 108.

Solving the partial differential equation provides surface continuity and smoothness as the forming tool 204 moves over the blank 100 along the tool path 206. The degree of smoothness is driven by the value of the positive integer k.

FIG. 16 is a cut-away illustration, along a slice plane 162, showing an example of the height of the addendum-shape 112 being equal to the height of the component-shape 104 along the Z-axis at any x, y coordinate along the component-boundary 106, as shown as a point of interest 156 on the first component-boundary 106A.

FIG. 16 also illustrates an example of the tangent plane of the addendum-shape 112 being coincident with the tangent plane of the component-shape 104 at any x, y coordinate along the component-boundary 106, as shown as a common tangent line 158 (e.g., slope, gradient) at the point of interest 156.

FIG. 16 also illustrates an example of a section plane 152 (e.g., an XY plane). A section curve is the curve resulting from the intersection of the structure 114 and the section plane 152. A slice curve is the curve resulting from the intersection of the structure 114 and the slice plane 162.

FIG. 16 further illustrates an example of the second fundamental form of the addendum-shape 112 being equal to the second fundamental form of the component-shape 104 at any x, y coordinate along the component-boundary 106, as shown as the osculating circle 160, which belongs to the point of interest 156 on the slice curve.

Generally, in differential geometry, the second fundamental form is a quadratic form on the tangent plane of a smooth surface in the three-dimensional Euclidean space, usually denoted by II (II tensor). Together with the first fundamental form, the second fundamental form serves to define extrinsic invariants of the surface, such as its principal curvatures.

In one or more examples, the common addendum 108 (e.g., the addendum-shape 112 or the surface geometry of the common addendum 108) generated according to the processes described herein has or is defined by a number of parameters, including, but not limited to: (1) being a continuous surface; (2) being a surface that is connected between the perimeter 110 (e.g., boundary or edge) of the blank 100 and the component-boundary 106 of each one of the component structures 102; (3) being a surface that can be represented in the form h(x, y), where h represents the height of the surface above the XY datum plane 154 for any point in the domain Ω with a pair of associated x, y-coordinates; (4) being a surface that satisfies the partial different equation ∇^{2k} h(x, y)=g(x, y) at all interior points on the surface, for some positive integer value for k and the surface being differentiable at least k times, where ∇ represents the gradient operator; and (5) being a surface that enforces the k^{th} order derivative of each one of the component structures 102 to be formed from the blank 100 along the component-boundary 106 associated with each one of the component structures 102.

For the case of k=1, the resulting differential operator is ∇², which is the harmonic operator (also known as the Laplacian), and the partial differential equation is:

$$\frac{{\partial }^{2} h ( x , y )}{\partial {x}^{2}} + \frac{{\partial }^{2} h ( x , y )}{\partial {y}^{2}} = g ( x , y )$$

For the case of k=2, the resulting differential operator is ∇⁴, which is the biharmonic operator, and the partial differential equation is:

$$\frac{{\partial }^{4} h ( x , y )}{\partial {x}^{4}} + 2 \frac{{\partial }^{4} h ( x , y )}{\partial {x}^{2} \partial {y}^{2}} + \frac{{\partial }^{4} h ( x , y )}{\partial {y}^{4}} = g ( x , y )$$

For the case of k=3, the resulting differential operator is ∇⁶, which is the triharmonic operator, and the partial differential equation is:

$$\frac{{\partial }^{6} h ( x , y )}{\partial {x}^{6}} + 3 \frac{{\partial }^{6} h ( x , y )}{\partial {x}^{4} \partial {y}^{2}} + 3 \frac{{\partial }^{6} h ( x , y )}{\partial {x}^{2} \partial {y}^{4}} + \frac{{\partial }^{6} h ( x , y )}{\partial {y}^{6}} = g ( x , y )$$

Referring now to FIG. 4, which schematically illustrates an example of the system 200 for forming the blank 100. In one or more examples, the system 200 enables implementation of or performs one or more of the operation steps described above with respect to the method 2000 (FIG. 1); the method 3000 (FIG. 2), and/or the method 4000 (FIG. 3).

In one or more examples, the system 200 includes the forming machine 208. The forming machine 208 is configured to form the target shape 150 from the blank 100. As described above, the forming machine 208 includes or takes the form of any suitable sheet forming machine, apparatus, or system. The forming machine 208 is configured to perform any suitable sheet forming operation, such as an incremental forming machine (e.g., single point incremental forming machine, two-point incremental forming machine, or dual-sided incremental forming machine), a die forming machine, a deep drawing machine, a stamping machine, a hydroforming machine, a superplastic forming machine, a creep forming machine, an explosive forming machine, and the like.

In one or more examples, the system 200 includes the computer 202. The computer 202 is configured to execute instructions to perform one or more of the operations of the method 2000, the method 3000, and/or the method 4000 described here. In one or more examples, the computer 202 is in communication with (e.g., is coupled to) the forming machine 208 and is configured to control (e.g., provide operational instructions to) the forming machine 208. In other examples, the forming machine 208 has a dedicated computer for controlling operation thereof.

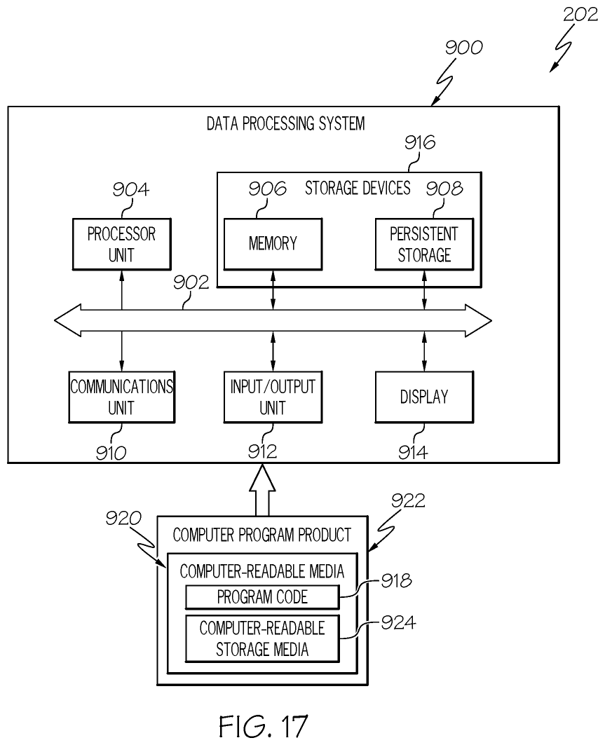

The computer 202 includes a data processing system 900 (e.g., as shown in FIG. 17). The computer 202 (e.g., the data processing system 900) includes a processor unit 904 and at least one storage device 916 (e.g., as shown in FIG. 17). The storage device 916 includes program code 918 (e.g., computer readable instructions). In one or more examples, the data processing system 900 is configured to perform a series of operations (e.g., one or more of the operational steps of the method 2000, the method 3000, and/or the method 4000). As an example, the data processing system 900 executes the program code 918 to cause the computer 202 to perform the series of operations.

In one or more examples, the data processing system 900 is configured to (e.g., execution of the program code 918 causes the computer 202 to) determine the component-shape 104 and the x, y coordinates of the component-boundary 106 of each one of component structures 102 to be formed from the blank 100.

In one or more examples, the data processing system 900 is configured to (e.g., execution of the program code 918 causes the computer 202 to) to generate the addendum-shape 112 of the common addendum 108 to be formed from the blank 100. The common addendum 108 extends between the component-boundary 106 of each one of component structures 102 and connects the component-boundary 106 of each one of the component structures 102 with the perimeter 110 of the blank 100.

In one or more examples, the data processing system 900 is configured to (e.g., execution of the program code 918 causes the computer 202 to) form the target shape 150 from the blank 100. The target shape 150 of the structure 114 formed from the blank 100 includes the component-shape 104 of the component structures 102 and the addendum-shape 112 of the common addendum 108.

In one or more examples, the system 200 also includes a machining tool 238. The machining tool 238 is configured to separate the common addendum 108 from the component structures 102 along the component-boundary 106 of each one of the component structures 102, thereby retaining only the components 116.

Referring still to FIG. 2, which also schematically illustrates an example of the structure 114 formed from the blank 100.

In one or more examples, the structure 114 includes a plurality of the component structures 102. Each one of the component structures 116 has the component-shape 104 and the component-boundary 106.

In one or more examples, the structure 114 also includes the common addendum 108. The common addendum 108 extends between the component-boundary 106 of each one of component structures 102. The common addendum 108 also connects the component-boundary 106 of each one of the component structures 102 with the perimeter 110 of the blank 100.

In one or more examples, the addendum-shape 112 of the common addendum 108 is generated using the computer 202 by representing the addendum-shape 112 as the function in a form of h(x, y) and by solving the partial differential equation of ∇^{2k} h(x, y)=g(x, y), subject to the boundary conditions, at the x, y coordinates on the XY datum plane 154 to obtain the function h(x, y).

In these examples, the function h(x, y) is a height of the addendum-shape 112 relative to the XY datum plane 154 for the x, y coordinates on the XY datum plane 154. The value k is a positive integer. The symbol ∇ represents the gradient operator. The function g(x, y) is the forcing function.

Accordingly, examples of the method 2000, the method 3000, the method 4000, and the system 200 enable determination of an entirety of the addendum-shape 112 by solving for the function h(x, y), in which the height depends on the x, y coordinates. The solution to the partial differential equation, in combination with the boundary conditions, results in the addendum-shape 112 that will form the common addendum 108 after forming of the target shape 150. As described above, in one or more examples, this solution is solved or otherwise calculated using a numerical technique, such as the finite difference method, spectral methods or Galerkin methods, such as the finite element method, isogeometric analysis methods, and the like.

The present disclosure recognizes that current methodologies for sheet forming, such as incremental sheet forming, generally include the following operations steps: (1) generate an appropriate addendum for a single component structure, (2) select an appropriately sized metal sheet for the component structure and the addendum; (3) form the structure, including the component structure and the addendum; (4) trim the addendum away from the component structure to leave the final component; and (5) discard the addendum and any remaining sheet material. Depending on the size and geometry of the component, the discarded addendum and remaining unformed sheet material can be significant. Additionally, for any given component structure, the time taken to form the addendum with some forming methods, such as incremental sheet forming, can be a significant portion of the total forming time. As such, the ability to minimize the addendum footprint (e.g., the projected surface area of the addendum 108) would provide numerous benefits.

Referring now to FIG. 5, which schematically illustrates an example of the structure 114, having the target shape 150, formed from the blank 100 using a sheet forming technique. As illustrated, when the structure 114 is completely formed, the structure 114 has the target shape 150 and includes the addendum 108, having the addendum-shape 112, and the component structure 102, having the component-shape 104 and the component-boundary 106. After formation of the structure 114, the addendum 108 is trimmed away and discarded (e.g., is metal scrap) which optionally may be recycled. The addendum 108 is required for formation of component structure 102. Without the improvements in addendum geometry determination described herein, there may be an unnecessarily large surface area consumed by the addendum 108 associated with the component structure 102.

As described above, implementations of the method 2000 (FIG. 1), the method 3000 (FIG. 2), the method 4000 (FIG. 3), and/or the system 200 (e.g., FIG. 2) enable multiple component structures 102 and the common addendum 108 to be formed from a single blank of sheet material (e.g., the blank 100). Implementations of the method 2000, the method 3000, the method 4000, and system 200 facilitate optimal placement of multiple component structures 102 formed from the blank 100 in such a way that the projected surface area of the common addendum 108 is reduced.

Generally, when generating an optimal configuration for the addendum-shape 112 of the common addendum 108, any non-overlapping placement of the component-shapes 104 of the component structures 102 is possible in the XY plane, provided that the addendum-shape 112 generated between the component structures 102 is formable. Offsets in Z-level (e.g., along the Z-axis), offsets in the planar position (e.g., along the X-axis and/or the Y-axis), and rotations around the X-axis, the Y-axis, and/or the Z-axis can aid in positioning to allow generation of an optimal instance of the addendum-shape 112 between and around all the component structures 102. The addendum-shape 112 of the common addendum 108 is enforced to have matching positions at the component-boundaries 106 of the component structures 102. The quality of the component structures 102 and, thus, the components 116 can be improved by enforcing the surface gradient and/or the curvature of the addendum-shape 112 to match at the component-boundaries 106 of the component structures 102. The position and orientation of the component structures 102 is a variant of a packing problem, which is addressed by implementations of the method 2000 and/or the system 200. The packing problem considers the tightest non-overlapping arrangement of a group of the component-shapes 104. Additionally, specific to the problem described herein, the packing problem is further complicated by the need for the component structures 102 to maintain the common addendum 108 (e.g., a material buffer) between them to allow the surface height, gradient, and curvature of the component-shapes 104 to change sufficiently smoothly as well as to facilitate the formability of the part in general.

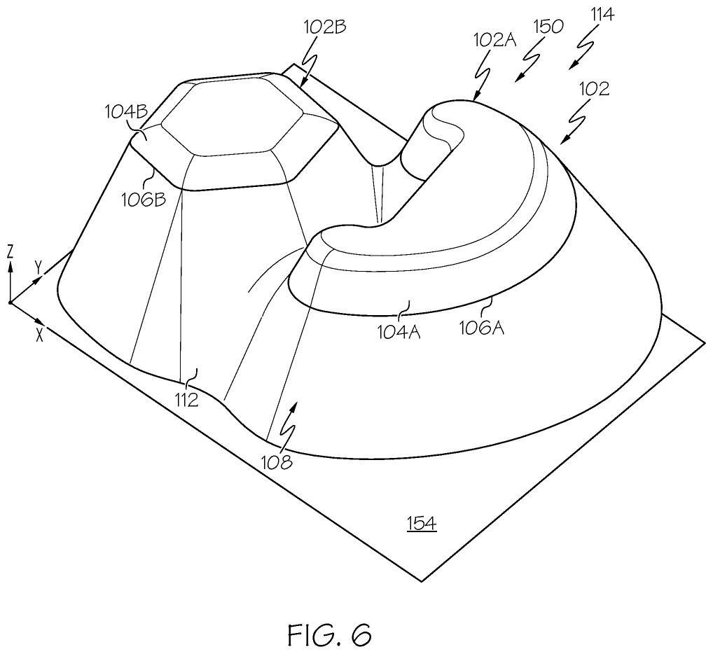

Referring now to FIG. 6, which illustrates another example of the structure 114 formed from the blank 100 using implementations of the method 2000 (FIG. 1), the method 3000 (FIG. 2), the method 4000 (FIG. 3) and/or the system 200 (FIG. 4). In the example illustrated in FIG. 6, the structure 114 includes two component structures 102 (e.g., a first component structure 102A and a second component structure 102B) and the common addendum 108. As illustrated, when the structure 114 is completely formed, the structure 114 has the target shape 150. The target shape 150 includes the component-shapes 104, associated with the component structures 102, and the addendum-shape 112, associated with the common addendum 108. In the illustrated example, the target shape 150 includes a first component-shape 104A and a second component-shape 104B, associated with the first component structure 102A and the second component structure 102B, respectively. In the illustrated example, the component-shapes 104 (e.g., first component-shape 104A and second component-shape 104B) of the component structures 102 are different. The common addendum 108 extends between the component-boundaries 106 (e.g., a first component-boundary 106A and a second component-boundary 106B) of the component structures 102 and connects the component-boundaries 106 of the component structures 102 with the perimeter 110 of the blank 100 when the target shape 150 of the structure 114 is fully formed.

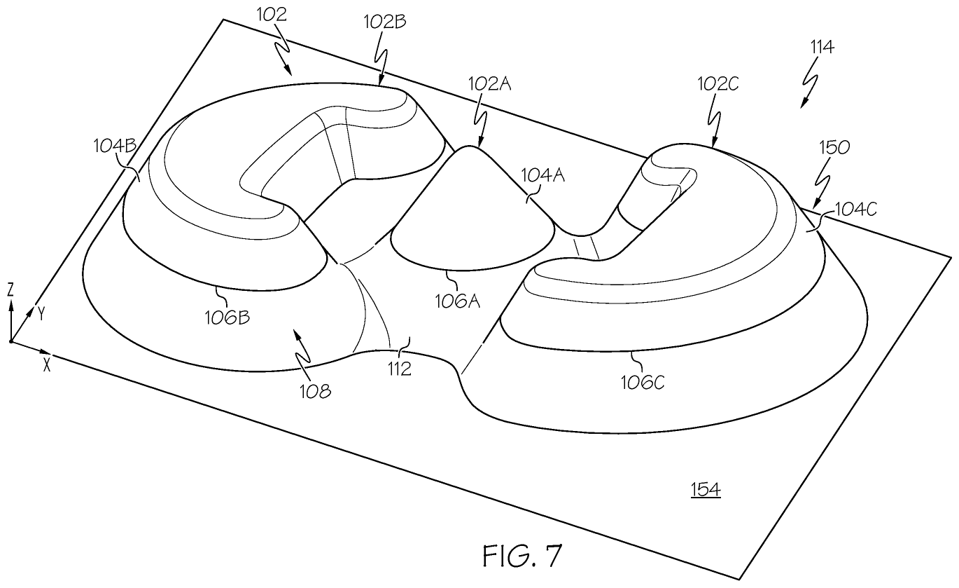

Referring now to FIG. 7, which illustrates an example of the structure 114 formed from the blank 100 using implementations of the method 2000 (FIG. 1), the method 3000 (FIG. 2), the method 4000 (FIG. 3), and/or the system 200 (e.g., FIG. 4). In the example illustrated in FIG. 7, the structure 114 includes three component structures 102 (e.g., a first component structure 102A, a second component structure 102B, and a third component structure 102C) and the common addendum 108. As illustrated, when the structure 114 is completely formed, the structure 114 has the target shape 150. The target shape 150 includes the component-shapes 104, associated with the component structures 102, and the addendum-shape 112, associated with common addendum 108. In the illustrated example, the target shape 150 includes a first component-shape 104A, a second component-shape 104B, and a third component-shape 104C associated with the first component structure 102A, the second component structure 102B, and the third component structure 102C, respectively. In the illustrated example, the component-shapes 104 of two of the component structures 102 (e.g., the second component-shape 104B and the third component-shape 104C) are the same and the component-shape 104 of one of the component structures 102 (e.g., the first component-shape 104A) is different. The common addendum 108 extends between the component-boundaries 106 (e.g., a first component-boundary 106A, a second component-boundary 106B, and a third component-boundary 106C) of the component structures 102 and connects the component-boundaries 106 of the component structures 102 with the perimeter 110 of the blank 100 when the target shape 150 of the structure 114 is fully formed.

Generally, FIGS. 6 and 7 illustrate an example arrangement of multiple component structures 102 that address the required buffer zone between the component structures 102 formed by the common addendum 108. The optimization problem is solved by minimizing the area of the projection of the common addendum 108 onto the XY plane (e.g., the footprint of the common addendum 108). As described herein above, in one or more examples, optimization is achieved through the method 3000 (FIG. 3).

Referring now to FIG. 8, which schematically illustrates an example of the incremental sheet forming operation for forming the blank 100 into the structure 114 (e.g., the structure 114 shown in FIG. 7) using the forming tool 204 (e.g., the stylus tool 222). In the example illustrated in FIG. 8, a frame (e.g., supports 240 shown in FIGS. 13-15), which clamps outer edges of the blank 100 is not shown. As illustrated, the forming tool 204 moves along the tool paths 206, which correspond to contours of the target shape 150, one level at a time to form the target shape 150 of the structure 114 from the blank 100. In the example shown in FIG. 8, three component structures 102 are being formed from the blank 100 (e.g., component structure 102A is partially formed and component structures 102B and 102C (e.g., as also shown in FIG. 7) will begin being formed as lower contours of the target shape 150 are reached). Each one of the component structures 102 (only one of the component structures 102A is shown in a partially formed condition) has the component-shape 104 and the component-boundary 106. The portions of FIG. 8 shown by broken lines illustrate the target shape 150 (e.g., the component structures 102 and the common addendum 108) after the forming operation is completed. In the illustrated example, two of the component-shapes 104 are the same (e.g., associated with the component structures 102B and 102C as shown in FIG. 7) and one of the component-shapes 104 is different (e.g., associated with component structure 102A as shown in FIG. 7). The addendum-shape 112 is generated, as described herein above, such that the common addendum 108 (e.g., as shown in FIG. 7) extends between the component-boundary 106 of each one of the component structures 102 and connects the component-boundary 106 of each one of the component structures 102 with the perimeter 110 of the blank 100 when the target shape 150 is fully formed.

Referring now to FIGS. 13-15, which schematically illustrate examples of the forming machine 208. The examples of the forming operation described below and illustrated in FIG. 13-15 are directed to different types of incremental sheet forming machines. However, in other examples, various other sheet forming techniques can also be used.

As shown in FIG. 13, in one or more examples, the forming machine 208 is or takes the form of a single point incremental forming machine. In these examples, the blank 100 is connected to supports 240 (e.g., clamping plates located proximate to the perimeter 110 of the blank 100). The forming machine 208 does not provide any backing support behind the stylus tool 222. The stylus tool 222 moves relative to the blank 100 according to the tool path 206 to form the target shape 150 in a layer-by-layer fashion.

As shown in FIGS. 14 and 15, in one or more examples, the forming machine 208 includes a complementary forming tool 236. The complementary forming tool 236 is used in combination with the forming tool 204 for forming the structure 114, having the target shape 150, from the blank 100.

As shown in FIG. 14, in one or more examples, the forming machine 208 is or takes the form of a two-point incremental forming machine. In these examples, the complementary forming tool 236 is the die 242. In these examples, the blank 100 is connected to the supports 240. The die 242 is positioned underneath the blank 100 for the stylus tool 222 to push against during incremental forming. The stylus tool 222 moves relative to the blank 100 according to the tool path 206 to form the target shape 150 in a layer-by-layer fashion.

As shown in FIG. 15, in one or more examples, the forming machine 208 is or takes the form of a dual-sided incremental forming machine. In these examples, the complementary forming tool 236 is a second stylus tool 248. In these examples, the blank 100 is connected to the supports 240. The second stylus tool 248 is positioned underneath the blank 100 for the stylus tool 222 to push against during incremental forming. The stylus tool 222 and the second stylus tool 248 move relative to the blank 100 (e.g., on each side of the blank 100) according to their respective tool paths 206 to form the target shape 150 in a layer-by-layer fashion.

Accordingly, in one or more examples, the method 2000 (FIG. 1) includes a step of supporting at least a portion of the blank 100 by the complementary forming tool 236 (e.g., shown in FIGS. 4, 14 and 15) during the step of (block 2016) forming the blank 100 into the target shape 150. In one or more examples, the complementary forming tool 236 contacts at least a portion of the blank 100 during at least a portion of the forming step (e.g., block 2016). At least the portion of the blank 100 in contact with the complementary forming tool 236 forms at least a subset of the target shape 150.

Referring now to FIG. 17, in one or more examples, the computer 202 (e.g., shown in FIG. 4) includes the data processing system 900. In one or more examples, the data processing system 900 includes a communications framework 902, which provides communications between at least one processor unit 904, one or more storage devices 916, such as memory 906 and/or persistent storage 908, a communications unit 910, an input/output (I/O) unit 912, and a display 914. In this example, the communications framework 902 takes the form of a bus system.

The processor unit 904 serves to execute instructions for software that can be loaded into the memory 906. In one or more examples, the processor unit 904 is a number of processors, a multi-processor core, or some other type of processor, depending on the particular implementation.

The memory 906 and the persistent storage 908 are examples of the storage devices 916. A storage device is any piece of hardware that is capable of storing information, such as, for example, without limitation, at least one of data, program code in functional form, or other suitable information either on a temporary basis, a permanent basis, or both on a temporary basis and a permanent basis. The storage devices 916 may also be referred to as computer readable storage devices in one or more examples. The memory 906 is, for example, a random-access memory or any other suitable volatile or non-volatile storage device. The persistent storage 908 can take various forms, depending on the particular implementation.

For example, the persistent storage 908 contains one or more components or devices. For example, the persistent storage 908 is a hard drive, a solid-state hard drive, a flash memory, a rewritable optical disk, a rewritable magnetic tape, or some combination of the above. The media used by the persistent storage 908 also can be removable. For example, a removable hard drive can be used for the persistent storage 908.

The communications unit 910 provides for communications with other data processing systems or devices. In one or more examples, the communications unit 91θ is a network interface card.

Input/output unit 912 allows for input and output of data with other devices that can be connected to the data processing system 900. As an example, the input/output unit 912 provides a connection for user input through at least one of a keyboard, a mouse, or some other suitable input device. Further, the input/output unit 912 can send output to a printer. The display 914 provides a mechanism to display information to a user.

Instructions for at least one of the operating system, applications, or programs can be located in the storage devices 916, which are in communication with the processor unit 904 through the communications framework 902. The processes of the various examples and operations described herein can be performed by the processor unit 904 using computer-implemented instructions, which can be located in a memory, such as the memory 906.

The instructions are referred to as program code, computer usable program code, or computer readable program code that can be read and executed by a processor of the processor unit 904. The program code in the different examples can be embodied on different physical or computer readable storage media, such as the memory 906 or the persistent storage 908.

In one or more examples, program code 918 is located in a functional form on computer readable media 920 that is selectively removable and can be loaded onto or transferred to the data processing system 900 for execution by the processor unit 904. In one or more examples, the program code 918 and computer readable media 920 form a computer program product 922. In one or more examples, the computer readable media 920 is computer readable storage media 924.

In one or more examples, the computer readable storage media 924 is a physical or tangible storage device used to store the program code 918 rather than a medium that propagates or transmits the program code 918.

Alternatively, the program code 918 can be transferred to the data processing system 900 using a computer readable signal media. The computer readable signal media can be, for example, a propagated data signal containing the program code 918. For example, the computer readable signal media can be at least one of an electromagnetic signal, an optical signal, or any other suitable type of signal. These signals can be transmitted over at least one of communications links, such as wireless communications links, optical fiber cable, coaxial cable, a wire, or any other suitable type of communications link.

The different components illustrated for data processing system 900 are not meant to provide architectural limitations to the manner in which different examples can be implemented. The different examples can be implemented in a data processing system including components in addition to or in place of those illustrated for the data processing system 900. Other components shown in FIG. 9 can be varied from the examples shown. The different examples can be implemented using any hardware device or system capable of running the program code 918.

Additionally, various components of the computer 202 and/or the data processing system 900 may be described as modules. For the purpose of the present disclosure, the term “module” includes hardware, software or a combination of hardware and software. As an example, a module can include one or more circuits configured to perform or execute the described functions or operations of the executed processes described herein (e.g., the method 2000, the method 3000, and/or the method 4000. As another example, a module includes a processor, a storage device (e.g., a memory), and computer-readable storage medium having instructions that, when executed by the processor causes the processor to perform or execute the described functions and operations. In one or more examples, a module takes the form of the program code 918 and the computer readable media 920 together forming the computer program product 922.

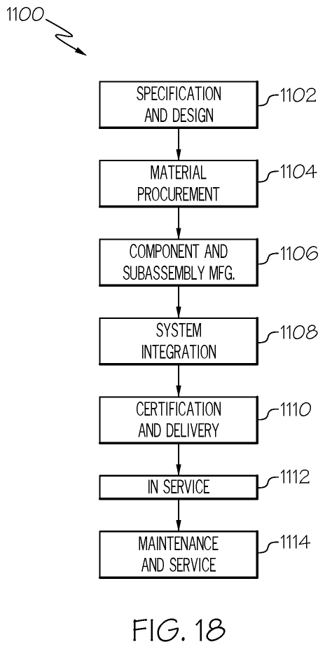

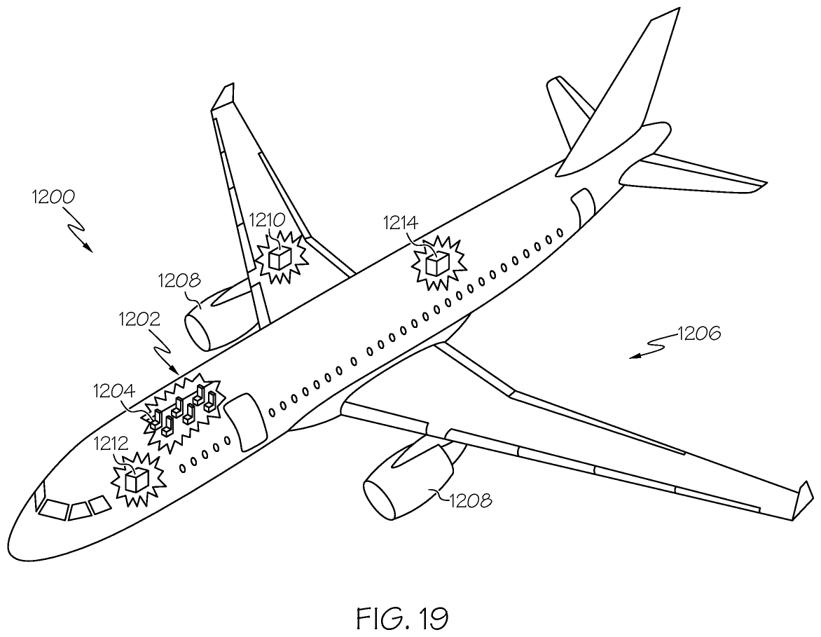

Referring now to FIGS. 18 and 19, examples of the method 2000, the method 3000, the method 4000, and the system 200, described herein, may be related to, or used in the context of, an aircraft manufacturing and service method 1100, as shown in the flow diagram of FIG. 18 and an aircraft 1200, as schematically illustrated in FIG. 19. For example, the aircraft 1200 and/or the aircraft production and service method 1100 may utilize metal components (e.g., components 116) formed from a blank of sheet material (e.g., blank 100) using the system 200 and/or according to the method 2000, the method 3000, and the method 4000.

Referring to FIG. 19, which illustrates an example of the aircraft 1200. The aircraft 1200 also includes an airframe 1202 having an interior 1204. The aircraft 1200 includes a plurality of onboard systems 1206 (e.g., high-level systems). Examples of the onboard systems 1206 of the aircraft 1200 include propulsion systems 1208, hydraulic systems 1210, electrical systems 1212, and environmental systems 1214. In other examples, the onboard systems 1206 also includes one or more control systems coupled to an airframe 1202 of the aircraft 1200, such as for example, flaps, spoilers, ailerons, slats, rudders, elevators, and trim tabs. In yet other examples, the onboard systems 1206 also includes one or more other systems, such as, but not limited to, communications systems, avionics systems, software distribution systems, network communications systems, passenger information/entertainment systems, guidance systems, radar systems, weapons systems, and the like.

Referring to FIG. 18, during pre-production of the aircraft 1200, the method 1100 includes specification and design of the aircraft 1200 (block 1102) and material procurement (block 1104). During production of the aircraft 1200, component and subassembly manufacturing (block 1106) and system integration (block 1108) of the aircraft 1200 take place. Thereafter, the aircraft 1200 goes through certification and delivery (block 1110) to be placed in service (block 1112). Routine maintenance and service (block 1114) includes modification, reconfiguration, refurbishment, etc. of one or more systems of the aircraft 1200.

Each of the processes of the method 1100 illustrated in FIG. 18 may be performed or carried out by a system integrator, a third party, and/or an operator (e.g., a customer). For the purposes of this description, a system integrator may include, without limitation, any number of spacecraft manufacturers and major-system subcontractors; a third party may include, without limitation, any number of vendors, subcontractors, and suppliers; and an operator may be an airline, leasing company, military entity, service organization, and so on.

Examples of the system 200 and/or the methods 2000, 3000, 4000 shown and described herein, may be employed during any one or more of the stages of the manufacturing and service method 1100 shown in the flow diagram illustrated by FIG. 18. In an example, forming metal components (e.g., the components 116) using the system 200 or according to the methods 2000, 3000, 4000 may form a portion of component and subassembly manufacturing (block 1106) and/or system integration (block 1108). Further, forming metal components (e.g., the components 116) using the system 200 or according to the methods 2000, 3000, 4000 may be implemented in a manner similar to components or subassemblies prepared while the aircraft 1200 is in service (block 1112). Also, metal components (e.g., the components 116) formed from a blank of sheet material (e.g., the blank 100) using the system 200 and/or according to the methods 2000, 3000, 4000 may be utilized during system integration (block 1108) and certification and delivery (block 1110). Similarly, metal components (e.g., the components 116) formed from a blank of sheet material (e.g., the blank 100) using the system 200 and/or according to the methods 2000, 3000, 4000 may be utilized, for example and without limitation, while the aircraft 1200 is in service (block 1112) and during maintenance and service (block 1114).

The preceding detailed description refers to the accompanying drawings, which illustrate specific examples described by the present disclosure. Other examples having different structures and operations do not depart from the scope of the present disclosure. Like reference numerals may refer to the same feature, element, or component in the different drawings. Throughout the present disclosure, any one of a plurality of items may be referred to individually as the item and a plurality of items may be referred to collectively as the items and may be referred to with like reference numerals. Moreover, as used herein, a feature, element, component, or step preceded with the word “a” or “an” should be understood as not excluding a plurality of features, elements, components or steps, unless such exclusion is explicitly recited.

Illustrative, non-exhaustive examples, which may be, but are not necessarily, claimed, of the subject matter according to the present disclosure are provided above. Reference herein to “example” means that one or more feature, structure, element, component, characteristic, and/or operational step described in connection with the example is included in at least one aspect, embodiment, and/or implementation of the subject matter according to the present disclosure. Thus, the phrases “an example,” “another example,” “one or more examples,” and similar language throughout the present disclosure may, but do not necessarily, refer to the same example. Further, the subject matter characterizing any one example may, but does not necessarily, include the subject matter characterizing any other example. Moreover, the subject matter characterizing any one example may be, but is not necessarily, combined with the subject matter characterizing any other example.

As used herein, a system, apparatus, device, structure, article, element, component, or hardware “configured to” perform a specified function is indeed capable of performing the specified function without any alteration, rather than merely having potential to perform the specified function after further modification. In other words, the system, apparatus, device, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware that enable the system, apparatus, structure, article, element, component, or hardware to perform the specified function without further modification. For purposes of this disclosure, a system, apparatus, device, structure, article, element, component, or hardware described as being “configured to” perform a particular function may additionally or alternatively be described as being “adapted to” and/or as being “operative to” perform that function.

Unless otherwise indicated, the terms “first,” “second,” “third,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, the phrase “at least one of”, when used with a list of items, means different combinations of one or more of the listed items may be used and only one of each item in the list may be needed. For example, “at least one of item A, item B, and item C” may include, without limitation, item A or item A and item B. This example also may include item A, item B, and item C, or item B and item C. In other examples, “at least one of” may be, for example, without limitation, two of item A, one of item B, and ten of item C; four of item B and seven of item C; and other suitable combinations. As used herein, the term “and/or” and the “/” symbol includes any and all combinations of one or more of the associated listed items.

For the purpose of this disclosure, the terms “coupled,” “coupling,” and similar terms refer to two or more elements that are joined, linked, fastened, attached, connected, put in communication, or otherwise associated (e.g., geometrically, mechanically, electrically, fluidly, optically, electromagnetically) with one another. In various examples, the elements may be associated directly or indirectly. As an example, element A may be directly associated with element B. As another example, element A may be indirectly associated with element B, for example, via another element C. It will be understood that not all associations among the various disclosed elements are necessarily represented. Accordingly, couplings other than those depicted in the figures may also exist.

As used herein, the term “approximately” refers to or represent a condition that is close to, but not exactly, the stated condition that still performs the desired function or achieves the desired result. As an example, the term “approximately” refers to a condition that is within an acceptable predetermined tolerance or accuracy, such as to a condition that is within 10% of the stated condition. However, the term “approximately” does not exclude a condition that is exactly the stated condition. As used herein, the term “substantially” refers to a condition that is essentially the stated condition that performs the desired function or achieves the desired result.

FIGS. 4-17 and 19, referred to above, may represent functional elements, features, or components thereof and do not necessarily imply any particular structure. Accordingly, modifications, additions and/or omissions may be made to the illustrated structure. Additionally, those skilled in the art will appreciate that not all elements, features, and/or components described and illustrated in FIGS. 4-17 and 19, referred to above, need be included in every example and not all elements, features, and/or components described herein are necessarily depicted in each illustrative example. Accordingly, some of the elements, features, and/or components described and illustrated in FIGS. 4-17 and 19 may be combined in various ways without the need to include other features described and illustrated in FIGS. 4-17 and 19, other drawing figures, and/or the accompanying disclosure, even though such combination or combinations are not explicitly illustrated herein. Similarly, additional features not limited to the examples presented, may be combined with some or all of the features shown and described herein. Unless otherwise explicitly stated, the schematic illustrations of the examples depicted in FIGS. 4-17 and 19, referred to above, are not meant to imply structural limitations with respect to the illustrative example. Rather, although one illustrative structure is indicated, it is to be understood that the structure may be modified when appropriate. Accordingly, modifications, additions and/or omissions may be made to the illustrated structure. Furthermore, elements, features, and/or components that serve a similar, or at least substantially similar, purpose are labeled with like numbers in each of FIGS. 4-17 and 19, and such elements, features, and/or components may not be discussed in detail herein with reference to each of FIGS. 4-17 and 19. Similarly, all elements, features, and/or components may not be labeled in each of FIGS. 4-17 and 19, but reference numerals associated therewith may be utilized herein for consistency.

In FIGS. 1-3 and 18, referred to above, the blocks may represent operations, steps, and/or portions thereof and lines connecting the various blocks do not imply any particular order or dependency of the operations or portions thereof. It will be understood that not all dependencies among the various disclosed operations are necessarily represented. In FIGS. 1-3 and 18 and the accompanying disclosure describing the operations of the disclosed methods set forth herein should not be interpreted as necessarily determining a sequence in which the operations are to be performed. Rather, although one illustrative order is indicated, it is to be understood that the sequence of the operations may be modified when appropriate. Accordingly, modifications, additions and/or omissions may be made to the operations illustrated and certain operations may be performed in a different order or simultaneously. Additionally, those skilled in the art will appreciate that not all operations described need be performed.

Further, references throughout the present specification to features, advantages, or similar language used herein do not imply that all of the features and advantages that may be realized with the examples disclosed herein should be, or are in, any single example. Rather, language referring to the features and advantages is understood to mean that a specific feature, advantage, or characteristic described in connection with an example is included in at least one example. Thus, discussion of features, advantages, and similar language used throughout the present disclosure may, but do not necessarily, refer to the same example.

The described features, advantages, and characteristics of one example may be combined in any suitable manner in one or more other examples. One skilled in the relevant art will recognize that the examples described herein may be practiced without one or more of the specific features or advantages of a particular example. In other instances, additional features and advantages may be recognized in certain examples that may not be present in all examples. Furthermore, although various examples of the system 200, the method 2000, the method 3000, and the method 4000 have been shown and described, modifications may occur to those skilled in the art upon reading the specification. The present application includes such modifications and is limited only by the scope of the claims.

What is claimed is:

1. A method for forming a blank of sheet material, the method comprising a step of:
forming a target shape from the blank,
wherein:
the target shape comprises a plurality of component structures connected via a common addendum;
each one of the plurality of component structures has a component-shape and a component-boundary; and
the common addendum extends between the component-boundary of each one of the plurality of component structures and connects the component-boundary of each one of the plurality of component structures with a perimeter of the blank.

2. The method of claim 1, wherein the step of forming the target shape comprises forming the plurality of component structures and the common addendum using a forming tool that interacts with the blank to elastoplastically deform the blank into the target shape.

3. The method of claim 1, further comprising separating the common addendum from each one of the plurality of component structures along the component-boundary in order to retain a plurality of components.

4. The method of claim 1, wherein the step of forming the target shape comprises operating a forming tool, with a computer, according to a tool path relative to the blank.

5. The method of claim 4, wherein the step of forming the target shape further comprises supporting at least a portion of the blank by a complementary forming tool.

6. The method of claim 1, wherein the step of forming the target shape comprises an incremental sheet forming operation.

7. The method of claim 1, wherein the step of forming the target shape comprises one of a deep drawing operation and a stamping operation.

8. The method of claim 1, wherein the step of forming the target shape comprises applying a hydroforming operation.

9. The method of claim 1, further comprising steps of:
determining, from a digital representation of each one of the plurality of component structures, x, y, and z coordinates of a plurality of points on the component-boundary of each one of the plurality of component structures to be formed from the blank; and
generating, with a computer, an addendum-shape of the common addendum.

10. The method of claim 9, wherein:
the step of generating the addendum-shape comprises:
representing the addendum-shape as a function h(x, y); and
solving a partial differential equation ∇^{2k} h(x, y)=g(x, y), subject to boundary conditions, at x, y coordinates on an XY datum plane to obtain the function h(x, y);
h(x, y) is a height of the addendum-shape relative to the XY datum plane for each one of the x, y coordinates in a domain Ω on the XY datum plane;
k is a positive integer;
∇ is the gradient operator; and
g(x, y) is a forcing function.

11. The method of claim 10, wherein, when a value of k is equal to 1, the height of the addendum-shape is equal to a height of the component-shape at any x, y coordinate along the component-boundary.

12. The method of claim 10, wherein, when a value of k is equal to 2, the height of the addendum-shape is equal to a height of the component-shape at any x, y coordinate along the component-boundary and a tangent plane of the addendum-shape is coincident with a tangent plane of the component-shape at any x, y coordinate along the component-boundary.

13. The method of claim 10, wherein, when a value of k is equal to 3, the height of the addendum-shape is equal to a height of the component-shape at any x, y coordinate along the component-boundary, a tangent plane of the addendum-shape is coincident with a tangent plane of the component-shape at any x, y coordinate along the component-boundary, and the second fundamental form of the addendum-shape is equal to the second fundamental form of the component-shape at any x, y coordinate along the component-boundary.

14. The method of claim 10, wherein the function h(x, y) for the height of the addendum-shape is computed by a finite difference method, comprising:
generating a subset of points that lie on the XY datum plane within the domain Ω, wherein the points are spaced in a grid having a regular pattern;
evaluating kernels corresponding to a harmonic operator (∇²), a bi-harmonic operator (∇⁴), or a higher order even differential operator (∇^{2k}, k∈Z⁺);
assembling quantities corresponding to evaluation of the kernel at each point in the grid into a matrix (A);
imposing at least one boundary condition;
subsequently modifying values contained with the matrix (A) according to at least the one boundary condition; and
solving a linear system Ah=θ,
wherein:
h is a column vector containing a height of each point in the grid; and
θ is a column vector resulting from a combination of at least the one boundary condition and the forcing function g(x, y).

15. The method of claim 10, wherein the function h(x, y) for the height of the addendum-shape is represented by a linear combination of a plurality of functions with compact support, computed by a Galerkin method, comprising:
generating at least one of a set of quadrilateral elements and a set of triangular elements that span a projection of the addendum-shape onto the XY datum plane, within the domain Ω, the elements defining the plurality of functions;
evaluating a weighted integral of a quantity dependent on an operator over an area spanned by compact supports;
assembling resulting quantities into a matrix (B);
imposing at least one boundary condition;
subsequently modifying values contained with the matrix (B) according to at least the one boundary condition; and
solving a linear system Bh=τ,
wherein:
h is a column vector containing function coefficients; and
τ is a column vector resulting from a combination of at least the one boundary condition and the forcing function g(x, y).

16. The method of claim 9, further comprising generating a die-shape for a die to be used for forming the plurality of component structures and the common addendum,
wherein the die comprises a die-surface configured to contact at least a portion of the blank to be formed into the target shape.

17. The method of claim 9, further comprising steps of:
specifying an initial orientation for the component-shape of each one of the plurality of component structures relative to a horizontal plane;
at least one of translating the component-shape of at least one of the plurality of component structures along at least one of an x-axis, a y-axis, and a z-axis and rotating the component-shape of at least one of the plurality of component structures about at least one of the x-axis, the y-axis, and the z-axis to minimize a surface area of the addendum-shape of the common addendum as projected onto the horizontal plane without the component-shape of any one of the plurality of component structures overlapping the component-shape any other one of the plurality of component structures;
generating the addendum-shape of the common addendum that spans an area between the component-boundary of each one of the plurality of component structures and the perimeter of the blank; and
generating the target shape by combining the addendum-shape of the common addendum and the component-shape of each one of the plurality of component structures.

18. The method of claim 17, wherein:
the step of generating the addendum-shape comprises solving a partial differential equation ∇^{2k} h(x, y)=g(x, y), k∈Z⁺; and
the partial differential ∇^{2k} h(x, y)=g(x, y), k∈Z⁺ is subject to the boundary conditions.

19. A structure formed from a blank of sheet material, the structure comprising:
a plurality of component structures, each one of the plurality of component structures having a component-shape and a component-boundary; and
a common addendum that extends between the component-boundary of each one of plurality of component structures and that connects the component-boundary of each one of the plurality of component structures with a perimeter of the blank,
wherein:
an addendum-shape of the common addendum is generated using a computer by representing the addendum-shape as a function h(x, y) and solving a partial differential equation of ∇^{2k} h(x, y)=g(x, y), subject to boundary conditions, for any point in a domain Ω with a pair of associated x, y coordinates to obtain the function h(x, y);
h(x, y) is a height of the addendum-shape relative to the XY datum plane for the x, y coordinates on the XY datum plane; and
k is a positive integer;
∇ is the gradient operator; and
g(x, y) is a forcing function.

20. A system for forming a blank of sheet material, the system comprising:
a forming machine configured to form a target shape from the blank; and
a computer in communication with the forming machine and configured to:
determine a component-shape and x, y coordinates of a component-boundary of each one of a plurality of component structures to be formed from the blank;
generate an addendum-shape of a common addendum to be formed from the blank, wherein the common addendum extends between a component-boundary of each one of plurality of component structures and connects the component-boundary of each one of the plurality of component structures with a perimeter of the blank; and
operate the forming machine to form the target shape, comprising the plurality of component structures and the common addendum, from the blank.
